(19) United States
(12) Patent Application Publication
(10) Pub. No.: US 2010/0112854 A1
(43) Pub. Date: May 6, 2010

(54) EASILY-GRIPPED COAXIAL CONNECTOR ELEMENT

(75) Inventor: Fabien BOURGEAS, Saint Nicolas de Macherin (FR)

Correspondence Address: OLIFF & BERRIDGE, PLC, P.O. BOX 320850, ALEXANDRIA, VA, 22320-4850, US

(73) Assignee: RADIALL, Rosny-Sous-Bois (FR)

(21) Appl. No.: 12/572,801

(22) Filed: Oct. 2, 2009

(30) Foreign Application Priority Data
Oct. 13, 2008 (FR) 08 56897

(51) Int. Cl. H01R 9/05

(52) U.S. Cl. 439/578

(57) ABSTRACT

The present invention relates to a coaxial connector element with a body; at least one central contact mounted in the body with interposed insulation; a flexible sleeve receiving a coaxial cable and defining a grip portion for gripping by a user; and a hollow plug including a helical groove for coupling with a complementary connector element; wherein the plug and the sleeve form a single integral unit.

### FIELD OF THE INVENTION

The present invention relates to a coaxial connector element. More particularly, the invention applies to coaxial connector elements for high resolution digital television of the BNC (bayonet Neill-Concelman) type, such connector elements being used for example to connect coaxial cables interconnecting various radiofrequency modules mounted in a bay. Nevertheless, the invention is not limited to this particular type of connector.

### BACKGROUND OF THE INVENTION

The grip surface of known connector elements for this type of application is defined only by the plug. As a result the grip surface is of relatively small extent, thereby making a coaxial cord including such a connector element difficult to manipulate in a dense environment or blind, where such an environment may be constituted for example by a bay for high resolution digital television.

It is known, e.g. from U.S. Pat. No. 312,814 to improve grip of a connector element by increasing the length of the plug, thereby requiring longer internal parts for the connector element, such as the body of the connector element or the central contact, and/or requiring special tooling to be developed in order to crimp the cable.

Application US 2002/0039853 discloses a connector element comprising a sleeve and a plug, the sleeve being constrained to turn with the plug by using an additional, intermediate part so as to enable the sleeve to be used as a grip portion. That solution presents the drawback of requiring recourse to an additional part for connecting the sleeve to the plug and of requiring a dual-injection method to be used for making the sleeve so as to obtain a sleeve that is mechanically sufficiently rigid to enable it to be gripped by a user, and sufficiently flexible to enable a cable to be passed through an opening provided in the sleeve.

Patent U.S. Pat. No. 4,746,305 discloses a coaxial connector having a plug in two portions without a flexible sleeve making it possible to accompany the movements of a coaxial cable to which the connector is connected.

Patent U.S. Pat. No. 6,808,407 also discloses a coaxial connector comprising a two-part plug without a flexible sleeve.

### OBJECT AND SUMMARY OF THE INVENTION

There exists a need to make it easier for a user to grip a coaxial cord including a coaxial connector element in an environment that is dense, or blind, and for this to be achieved in a manner that is simple and inexpensive.

The invention seeks to satisfy this need and it achieves this object by a coaxial cable element comprising:

a body;

at least one central contact mounted in the body with interposed insulation;

a flexible sleeve receiving a coaxial cable and defining a grip portion for gripping by a user; and

a hollow plug including a helical groove for coupling with a complementary connector element;

wherein the plug and the sleeve form a single integral unit.

By making the plug and the sleeve as an integral unit, the invention enables the sleeve to be used as a grip portion.

Unlike known solutions, the invention enables a grip portion to be obtained of greater or shorter length depending on the intended application, without it being necessary to modify the length of the body and of the internal parts of the connector element, in particular of the central contact and of the insulation of the connector.

The sleeve is advantageously configured to protect the coaxial cable and to accompany the movements thereof.

By way of example, the sleeve is in direct contact with the coaxial cable. The sleeve may be configured to allow the coaxial cable to move, e.g. in twisting, when received in the sleeve.

In a first exemplary embodiment of the invention, the plug and the sleeve are distinct parts and include co-operating portions in relief to enable the plug and the sleeve to be fastened together permanently.

In this first exemplary embodiment, the plug and the sleeve are fastened together in permanent manner, which means that the two parts assembled together in this way cannot be taken apart by a user.

The plug includes a rear portion advantageously having at least one key on its outside surface, the sleeve including a front portion advantageously having at least one setback formed in its inside surface, and the key is advantageously arranged to be inserted in the setback when fastening the plug and the sleeve together, thereby preventing the sleeve and the plug from turning relative to each other.

The rear portion of the plug advantageously includes at least one ring on its outside surface, the ring extending over at least a fraction of the periphery of said rear portion, the front portion of the sleeve advantageously includes a groove arranged in at least a fraction of the periphery of its inside surface, and the ring is advantageously arranged to be inserted in the groove when the plug and the sleeve are fastened together, thereby preventing the sleeve and the plug from translating relative to each other.

By means of the invention, the plug and the sleeve are secured to each other without requiring an additional part.

The plug is advantageously made of a plastics material, e.g. by injection molding, thereby enabling electrical insulation properties to be provided that enable a user to use the connector element in complete safety when connecting a coaxial cable to the bay. In addition, the use of a plastics material leads to a saving in weight that may also constitute an economic advantage.

Said plastics material is advantageously transparent, thereby enabling the body of the connector element to be made visible to the user.

The sleeve is advantageously made of plastics material, said plastics material including coloring, for example, thereby enabling a coding type function to be added to the sleeve and making the sleeve easier to identify by a user.

In a second exemplary embodiment of the invention, the plug and the sleeve are made as a single piece, e.g. by dual injection or by overmolding.

The plug and the sleeve may be made of plastics material, for example.

In the second exemplary embodiment, the invention enables the number of parts to be reduced even further, the single piece acting both as a plug and as a sleeve, thereby simplifying assembly of the connector element and providing the user with electrical protection when handling the connector element.

The plastics material of the plug and/or that of the sleeve advantageously include phosphorescent additives, thereby enabling the connector element to be easier to see in surroundings that are dense and/or dark.

The plug advantageously includes at least one resilient tab projecting towards the inside, the body advantageously including in its outside surface at least one groove, and the resilient tab is advantageously arranged to be inserted in the groove when the plug is mounted on the body.

In a variant, the plug includes at least one cavity and the connector element includes at least one ring with at least one lug. Said lug is shaped so as to co-operate with said cavity in such a manner as to prevent movement in translation in either direction between the body and the plug and to prevent any rotation between these two parts.

The body may include a groove in its outside surface extending over all or a fraction of said surface and bordered on one side by a first shoulder.

Advantageously, the connector element includes a resilient ring capable of moving out from the groove beyond the first shoulder and a flat split ring that is freely movable in translation in the groove and that is capable of coming into abutment against the first shoulder.

The stopping of the flat ring by the first shoulder of the element enables non-functional compression of the resilient ring to be avoided by preventing the flat split ring from moving out from the groove, thereby reducing any risks of the resilient ring being destroyed.

When connecting such a connector element to a complementary connector element, the spring function of said connector element is advantageously provided by the resilient ring bearing against the flat ring, itself bearing against the plug.

By means of the shoulder, the groove may be adjusted to the stroke that corresponds to the helical groove in the sleeve, thereby enabling the lifetime of the connector to be increased.

The front face of the plug may be cut into a cup shape, in order to make bayonet coupling easier.

The plug and/or the sleeve may include at least one projection projecting from their outside surface and may present a profile that is oval or elliptical, thereby facilitating positioning relative to the helical groove of the plug, facilitating grip by a user, and possibly acting as a visible connection indicator.

In the invention, the assembly constituted by the plug and the sleeve may for example be separable from the body, thus making it possible, where appropriate, to perform maintenance operations on the connector element without destroying the plug and/or the sleeve. In addition, the invention makes it possible to improve guidance between the body and the assembly constituted by the plug and the sleeve.

By way of example, the connector element may be of the BNC type.

In non-limiting manner, the connector element may for example be a connector element presenting an impedance of 75 ohms (Ω).

Other exemplary embodiments of the invention also provide a coaxial cord comprising:

a coaxial cable; and

a connector element as defined above mounted on at least one end of the cable.

### BRIEF DESCRIPTION OF THE DRAWINGS

Other advantages and characteristics of the invention appear on reading the following description of non-limiting embodiments given with reference to the accompanying drawings, in which:

FIG. 1 is an exploded view of a connector element of the invention;

FIG. 2 shows a plug and a sleeve in a first embodiment of the invention prior to being fastened together;

FIG. 3 is a section view of the plug, the sleeve, and the body in the first embodiment of the invention;

FIG. 4 is a perspective view of a portion of a coaxial cord in accordance with the first embodiment of the invention;

FIG. 5 is a section view of the plug and the sleeve in a second embodiment of the invention; and

FIGS. 6 to 8 are respectively an overall view of the body, the plug, and the sleeve in a third embodiment of the invention, a section view when the plug is mounted on the body and a detail view of the FIG. 6 connector element.

### MORE DETAILED DESCRIPTION

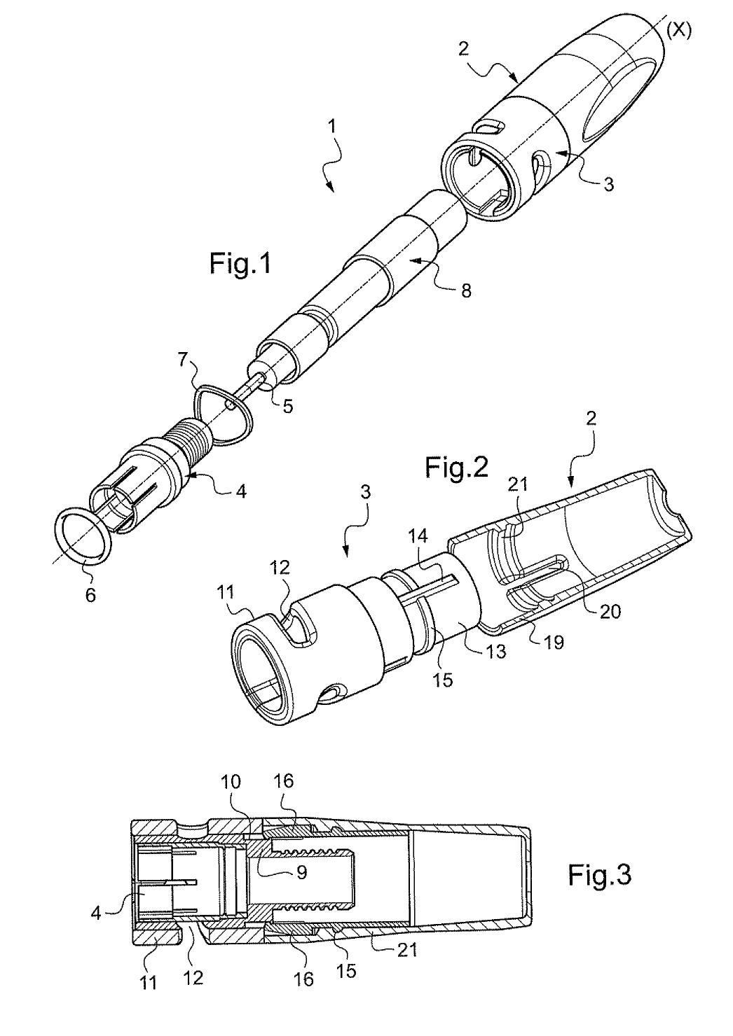

FIG. 1 shows an example of a connector element given overall reference 1 and constituting a first embodiment of the invention.

The connector element 1 presents a longitudinal axis X and includes a sleeve given overall reference 2 and a hollow plug given overall reference 3 that are shown in FIG. 1 prior to being fastened together, the sleeve 2 and the plug 3 in this first embodiment being two distinct parts.

The connector element 1 also includes a body given overall reference 4, a central contact 5, insulation that is not shown, a gasket 6, a resilient ring 7, and a ferrule 8 for crimping onto a coaxial cable.

As can be seen in FIG. 3, the body 4 includes a rear portion 9 having a groove 10 formed in the outside surface thereof for a purpose that is described below. In the example described, the groove 10 is an annular groove.

FIG. 2 shows an example of a sleeve 2 and a plug 3 of the invention prior to them being fastened together.

As can be seen, the hollow plug 3 has a front portion 11 in which a helical groove 12 is provided that enables the plug to be fastened to a complementary connector by bayonet coupling. The plug 3 also has a rear portion 13 with portions in relief 14 and 15 arranged on its outside surface. In the example described, two keys 14 are made integrally with the outside surface of the rear portion 13 of the plug 2 and are diametrically opposite each other, however these two keys could be arranged differently on said outside surface.

The rear portion 13 of the plug 3 also includes a ring 15 that, in the example described, extends around the outside surface of said rear portion 13 of the plug 3.

As shown in FIG. 3, the rear portion 13 also includes two resilient tabs 16 projecting outwards for a purpose that is described below.

By way of example, the plug 3 is made by injection molding a transparent plastics material, e.g. a polycarbonate.

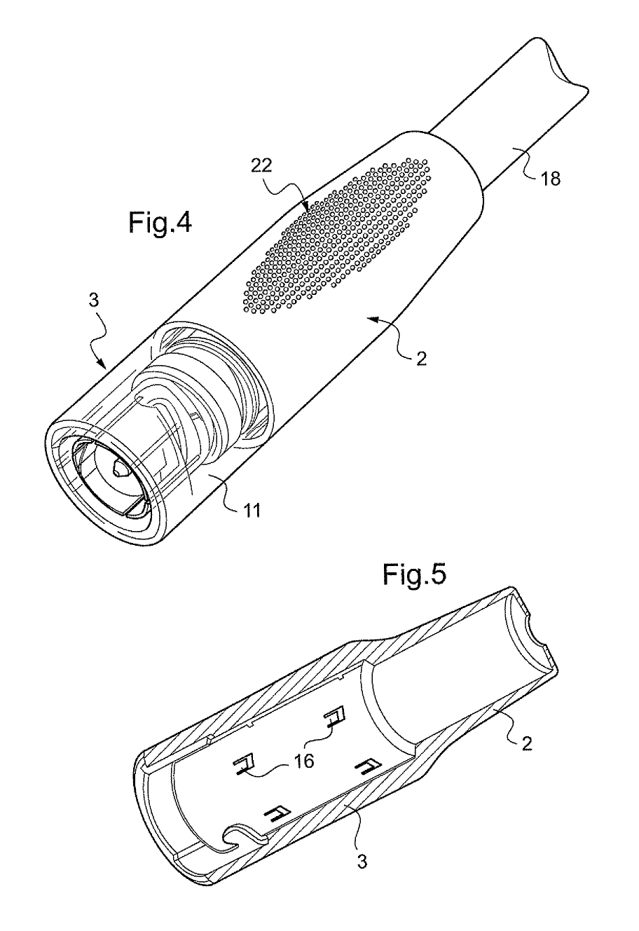

The sleeve 2 defines a housing 17 suitable for receiving the rear portion 13 of the plug 3 and a coaxial cable 18, as shown in FIG. 4. As can be seen in FIG. 2, the sleeve has a front portion 19 with an inside surface that is provided with portions in relief 20 and 21.

In the example described, the inside surface of the front portion 19 of the sleeve 2 includes two setbacks 20 extending longitudinally, and an annular groove 21 extending around the periphery of the inside surface of the front portion 19 of the sleeve.

By way of example, the sleeve 2 is made of a flexible plastics material, e.g. polyurethane, and this plastics material may include a coloring additive, so as to give a coding function to the sleeve in addition to functions of protecting the coaxial cable and accompanying the movements thereof.

The sleeve 2 and the plug 3 may both be made of plastics material including phosphorescent additives, advantageously selected appropriately for the corresponding plastics material.

As can be seen in FIG. 4, the plug 3 may present an outside surface that does not have any portions in relief, so as to define a surface that is smooth.

The sleeve 2 may advantageously be arranged in such a manner that its outside surface defines a grip portion 22, this grip portion 22 being obtained for example by knurling or by forming a rough zone.

In the first embodiment of the invention, when assembling the connector element 1, the sleeve 2 and the plug 3 are initially fastened to each other, in such a manner as to ensure that they cannot subsequently be taken apart by a user. As shown in FIG. 2, the rear portion 13 of the plug 3 is inserted into the front portion 19 of the sleeve 2. Each key 14 is then received in a corresponding setback 20. Furthermore, the ring 15 is received in the annular groove 21.

The assembly obtained in this way is then mounted on the body 4 and each resilient tab 16 comes to bear in the annular groove 10 to hold said assembly on the body 4.

The invention is not restricted to any particular number or shape for the keys 14, the ring 15, the setback 20, the groove 21, the resilient tab 16, and the groove 10.

FIG. 5 shows the second embodiment of the invention. As can be seen, the plug 3 may be made integrally with the sleeve 2, e.g. by dual injection or by overmolding a plastics material. The inside surface of the sleeve 2 has resilient tabs 16 similar to those described with reference to FIG. 3.

The invention is not limited to the examples described above.

Although the examples described relate to a connector element for connecting to a corresponding connector element by means of a bayonet coupling to produce a BNC type connector, the invention may be applied to connector elements using other types of coupling.

Although, in the examples described, the connector element has only one central contact, the invention does not exclude the presence of more than one central contact for the connector element, e.g. two central contacts.

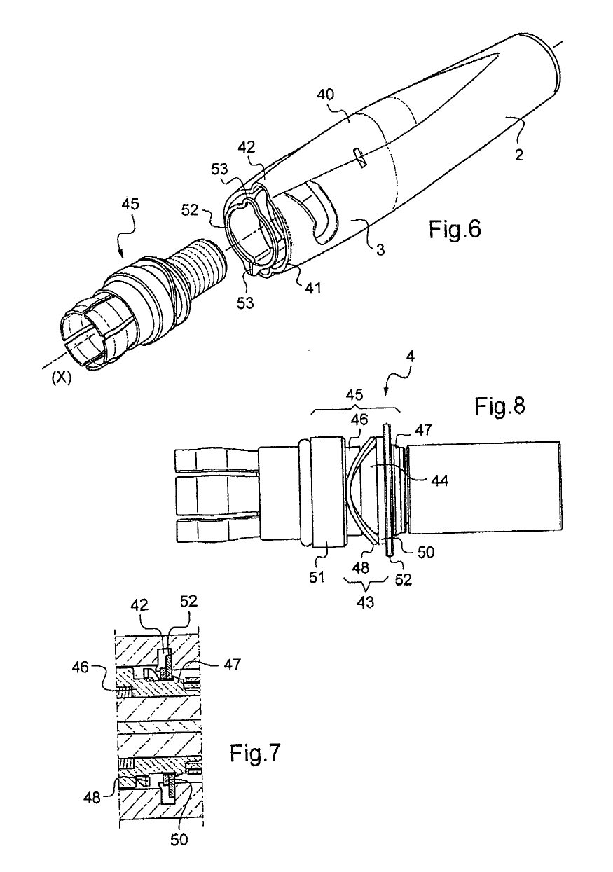

FIG. 6 shows a third embodiment of the invention.

In this embodiment, the plug 3 and the sleeve 2 may be made as a single piece, as described for the second embodiment of the invention, or they may be made as two distinct parts that are fastened together, as described for the first embodiment of the invention.

As shown, in the example under description, the plug 3 and the sleeve 2 include a projection 40 extending along the longitudinal axis X. This projection 40 may extend over the entire length of the sleeve and/or of the plug or over a portion only thereof. The projection 40 in the example described extends continuously, but in a variant it could extend discontinuously.

As shown in FIG. 6, at least towards the front end 41 of the plug 3, the projection 40 may be hollow, so as to define a cavity 42 for a purpose that is described below. In the embodiment described, the plug 3 and the sleeve 2 include two diametrically-opposite projections 40 each defining a cavity 42.

Still in the embodiment shown, the plug 3 and the sleeve 2 present a profile that is oval or elliptical.

There follows a description of the body 4 with reference to FIG. 8.

As may be seen, the body includes a middle portion 45 within which there is defined a main groove 43 that, in the embodiment described, extends all away around the longitudinal axis (X) of the body. A secondary groove 44 is formed in said main groove 43, at the rear end thereof.

As shown in FIG. 8, the main groove 43 is bordered towards the front by a collar 51 and towards the rear by a second shoulder 47. The secondary groove 44 is bordered towards the front of the body 4 by a first shoulder 46 formed in the bottom of the main groove 43, and towards the rear of the body 4 by a second shoulder 47. A resilient ring 48 is received in the middle portion 45, the ring 48 coming into rear abutment against a flat split ring 50 that is mounted by force in the secondary groove 44 and that prevents forward movement in translation against the first shoulder 46. The resilient ring 48 can move forwards in the middle portion 45 beyond the secondary groove 44, e.g. coming into abutment against the collar 51.

The flat ring 50 constitutes a rear stop against movement in translation of the resilient ring 48, serving, once assembly has been completed, to prevent the resilient ring 48 from escaping from the main groove 43.

As shown in FIGS. 6 and 8, the connector element 1 in the embodiment shown may also include a ring 52 with two lugs 53. In the embodiment described, each lug 53 is configured to be received inside a cavity 42, such that the ring 52 is prevented from turning relative to the plug 3. When the assembly formed by the sleeve 3 and the plug 2 is mounted on the body 4, said assembly is taken towards the body 4 by being slid along the coaxial cable until the ring 52 snap-fastens in the groove 42 between the second shoulder 47 and the flat split ring 50, as shown in FIG. 7.

The invention provides a solution that is less expensive than known solutions for improving grip on a coaxial cord, and it does so by simplifying factory assembly of the connector element, by making use of fewer component parts for making the connector element, and by presenting a solution that is lighter in weight.

The invention also makes it possible to use the same plug and/or the same plug for coaxial cables of different diameters.

1. A coaxial connector element comprising:
a body;
at least one central contact mounted in the body with interposed insulation;
a flexible sleeve receiving a coaxial cable and defining a grip portion for gripping by a user; and
a hollow plug including a helical groove for coupling with a complementary connector element; wherein the plug and the sleeve form a single integral unit.

2. A connector element according to claim 1, wherein the plug and the sleeve are distinct parts and include co-operating portions in relief to enable the plug and the sleeve to be fastened together permanently.

3. A connector element according to claim 2, wherein:
the plug includes a rear portion having at least one key on its outside surface;
the sleeve includes a front portion having at least one setback formed in its inside surface; and
the key is arranged to be inserted in the setback when fastening the plug and the sleeve together.

4. A connector element according to claim 3, wherein:
the rear portion of the plug includes at least one ring on its outside surface, the ring extending over at least a fraction of the periphery of the rear portion;
the front portion of the sleeve includes a groove formed in at least a portion of the periphery of its inside surface; and
the ring is arranged to be inserted into the groove when fastening the plug on the sleeve.

5. A connector element according to claim 1, wherein the plug is made of plastics material.

6. A connector element according to claim 5, wherein said plastics material is transparent.

7. A connector element according to claim 1, wherein the sleeve is made of plastics material.

8. A connector element according to claim 7, wherein said plastics material includes a coloring additive.

9. A connector element according to claim 1, wherein the plug and the sleeve are made as a single piece.

10. A connector element according to claim 9, wherein the plug and the sleeve are made of plastics material.

11. A connector element according to claim 5, wherein the plastics material of the plug and/or the plastics material of the sleeve include(s) phosphorescent additives.

12. A connector element according to claim 1, wherein the plug includes at least one cavity and wherein the connector element includes at least one ring having at least one lug, said lug being configured to co-operate with said cavity so as to hold the body and the plug together.

13. A connector element according to claim 12, wherein the body includes a groove in its outside surface extending around all or part of said outside surface and bordered on one side by a first shoulder, and wherein the connector element includes a resilient ring capable of moving out from the groove beyond the first shoulder, and a flat split ring that is freely movable in translation in the groove and that is capable of coming into abutment against the first shoulder.

14. A connector element according to claim 12, wherein the front face of the plug is cut into a cup shape.

15. A connector element according to claim 12, wherein the plug and/or the sleeve include a projection projecting from their outside surface, and wherein the plug and/or the sleeve present a profile that is elliptical or oval.

16. A connector element according to claim 10, wherein the plastics material of the plug and/or the plastics material of the sleeve include(s) phosphorescent additives.
